(19) United States
(12) Patent Application Publication
(10) Pub. No.: US 2005/0053725 A1
(43) Pub. Date: Mar. 10, 2005

(54) Method and apparatus for discharging liquid crystal, liquid crystal device, manufacturing method thereof and electronic equipment

(75) Inventor: Yuji Iwata, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/887,820

(22) Filed: Jul. 12, 2004

(30) Foreign Application Priority Data
Jul. 14, 2003 (JP) 2003-196498

(51) Int. Cl. B05D 3/02

(52) U.S. Cl. 427/375; 427/162; 118/715

(57) ABSTRACT

Aspects of the invention provide a method that discharges and allocates stably a given amount of liquid crystal by securely filling the liquid crystal in a discharge head. More particularly, the invention can provide a method for discharging the liquid crystal in which the liquid crystal is discharged from a discharge head and disposed in a predetermined area of a substrate. And the method can include a heat processing in which the liquid crystal is heated until it reaches a temperature which exceeds its transition point.

### BACKGROUND OF THE INVENTION

1. Field of Invention

The invention relates to method and apparatus for discharging liquid crystal. The invention also relates to liquid crystal device, manufacturing method thereof and electronic equipment.

2. Description of Related Art

In a liquid crystal device, for example, liquid crystal disposed within a liquid crystal panel is used as a part of a control means for displaying. To dispose the liquid crystal within such liquid crystal panel, the liquid crystal panel is firstly formed by bonding two substrates, then, form a vacuum within the liquid crystal panel and let the panel suck in the liquid crystal. However, above-described method has disadvantages, such as that a huge amount of the liquid crystal is consumed and it takes a long time to produce the each liquid crystal panel.

In order to overcome the disadvantages, a technique, which is, using an inkjet apparatus and the like to dispose the liquid crystal on the substrate before bonding the two substrates, has been suggested. In this technique, the liquid crystal, which is a high viscosity material, is heated to reduce its viscosity before discharging. In other words, the liquid crystal is heated until it reaches a temperature which the liquid crystal can be discharged by the inkjet apparatus and the like. With the inkjet apparatus, a little amount of the liquid crystal is consumed and it is possible to dispose the liquid crystal with high resolution. See, for example, Japanese Unexamined Patent Laid-Open Publication No. 2003-19790.

### SUMMARY OF THE INVENTION

However, even when the liquid crystal is heated until it reaches the temperature which the liquid crystal can be discharged, a discharge nozzle provided in a discharge head can be clogged. This is attributed to the fact that air bubbles are caught in the discharge nozzle when the liquid crystal is first filled in the discharge head from where the liquid crystal is stored, even when the liquid crystal is heated till it becomes of a right viscosity in which the liquid crystal can be discharged. When the liquid crystal is discharged by using the clogged discharge nozzle, a given amount of the liquid crystal can not be put in a predetermined area. Consequently, a display will be lacking in uniformity and a light emission characteristics will be degraded.

An aspect of invention has been developed in consideration of the above-mentioned problems, and intended to provide a method and an apparatus for discharging liquid crystal which stably discharges and allocates a given amount of liquid crystal by securely filling the liquid crystal in a discharge head.

A degree of the viscosity which is not exceeding approximately 20 cp is regarded as a dischargeable viscosity for a commonly used apparatus for discharging the liquid crystal. However, as described above, the discharge nozzle can be clogged at about 20 cp, so that making the viscosity of the liquid crystal 10 cp or less, for example, stabilize a discharging operation. Also, when the liquid crystal is first filled in the discharge head from a tank where the liquid crystal is stored in a state which the discharge head and a path of flow are unfilled, the viscosity of the liquid crystal is set to be, for example, 5 cp to increase its liquidity and its filling reliability.

FIG. 1 is a table showing a relationship between a temperature and a viscosity of a liquid crystal A that is used in an after-mentioned discharge method. It can be seen from the table that the viscosity of the liquid crystal A suddenly drops about at 100° C. This temperature is a transition point in which the liquid crystal A completely turns to liquid from a coexistence state of a liquid phase and a solid phase.

An exemplary method for discharging liquid crystal according to the invention is a method in which the liquid crystal can be discharged from a discharge head and disposed in a predetermined area on a substrate, and includes a heat processing in which the liquid crystal is heated till it reaches a temperature that exceeds its transition point.

An exemplary apparatus for discharging liquid crystal according to the invention can include a discharge head from which the liquid crystal is discharged and disposed in a predetermined area on a substrate, and a first heater heating the liquid crystal in the discharge head till it reaches a temperature that exceeds its transition point.

According to the exemplary method and the apparatus for discharging liquid crystal, since the liquid crystal is heated to the temperature that exceeds the transition point, its viscosity is extremely reduced as shown in FIG. 1. Therefore, the discharge head and the path of flow of the liquid crystal are hardly clogged, and a predetermined amount of the liquid crystal is stably discharged and allocated by securely filling the liquid crystal in the discharge head.

In the method for discharging liquid crystal according to the invention, a first charging process in which the liquid crystal is charged in the discharge head may be included, and it is preferable that the heat processing is carried out in the first charging process.

In the apparatus for discharging liquid crystal according to the invention, a suction device suctioning up an inside of the discharge head at an negative pressure and charging the liquid crystal into the discharge head may be included. Also, a controller controlling the first heater to heat the liquid crystal at least till it reaches the temperature that exceeds the transition point when the suction device suctions the liquid crystal into the discharge head may be included.

According to the above-described features, the liquid crystal, that is charged in the discharge head that was filled with the air or a certain gas, has a temperature that exceeds its transition point. Therefore the liquid crystal is charged in the discharge head without catching air bubbles since its viscosity is reduced enough. Consequently, a predetermined amount of the liquid crystal is more stably discharged and allocated by securely filling the liquid crystal in the discharge head.

Further, the liquid crystal is easily charged in the discharge head without suctioning to an excessive degree, since its viscosity is reduced enough. Therefore, the first charging process in which a requisite minimum amount of the liquid crystal is charged in the discharge head becomes possible.

In the exemplary apparatus for discharging liquid crystal, a liquid crystal tank in which the liquid crystal is stored, a path of flow connecting the liquid crystal tank and the discharge head, a second heater heating the liquid crystal tank and a third heater heating the path of flow may be included. Since the second and third heater have already heated the liquid crystal in the liquid crystal tank and the path of flow, the liquid crystal in the discharge head is easily heated till it reaches the temperature that exceeds the transition point.

The liquid crystal tank and the path of flow may be heated to the temperature that exceeds the transition point by the second and third heater.

An exemplary method of manufacturing a liquid crystal device according to the invention can include a liquid crystal discharging and disposing process in which the liquid crystal is allocated in a predetermined area on a substrate by the method for discharging liquid crystal. According to the method of manufacturing a liquid crystal, the liquid crystal is allocated by the above-described method of manufacturing a liquid crystal in the liquid crystal discharging and disposing process. Therefore, a liquid crystal device in which a predetermined amount of the liquid crystal is certainly disposed can be provided, since the liquid crystal is discharged from the discharge head (the discharge nozzle) without clogging it. This prevents display unevenness from occurring, as a consequent, visibility of the liquid crystal device is improved.

An exemplary electronic equipment according to the invention can include the above-described liquid crystal device as a display device. Therefore, its visibility is also improved.

### BRIEF DESCRIPTION OF THE DRAWINGS

The invention will be described with reference to the accompanying drawings, wherein like numerals reference like elements, and wherein:

FIG. 1 is a table showing a relationship between a temperature and a viscosity of liquid crystal;

FIG. 2 is a schematic perspective view showing a structure of an inkjet apparatus;

FIG. 3 is a schematic view showing a suction mechanism;

FIG. 4 is an exploded perspective view of a discharge head;

FIG. 5 is an exemplary block diagram showing a control system for a discharging operation;

FIG. 6 is an exemplary block diagram showing a structure which controls a temperature;

FIG. 7 is a flowchart showing procedures of a method for discharging the liquid crystal;

FIG. 8 is a section view showing a frame format of a structure of a liquid crystal device;

FIG. 9(a) is a first schematic view showing a step for manufacturing the liquid crystal device;

FIG. 9(b) is a second schematic view showing a step following the one shown in FIG. 9(a);

FIG. 9(c) is a third schematic view showing a step following the one shown in FIG. 9(b);

FIG. 9(d) is a fourth schematic view showing a step following the one shown in FIG. 9(c);

FIG. 10(a) is showing a first specific example of an electronic equipment;

FIG. 10(b) is showing a second specific example of the electronic equipment; and

FIG. 10(c) is showing a third specific example of the electronic equipment.

### DETAILED DESCRIPTION OF PREFERRED EMBODIMENTS

Embodiments of a method and an apparatus for discharging liquid crystal, a liquid crystal device, manufacturing method thereof and electronic equipment according to the invention are described with reference to figures. In the figures, a scale size may be different in each layer or each member in order to make those recognizable.

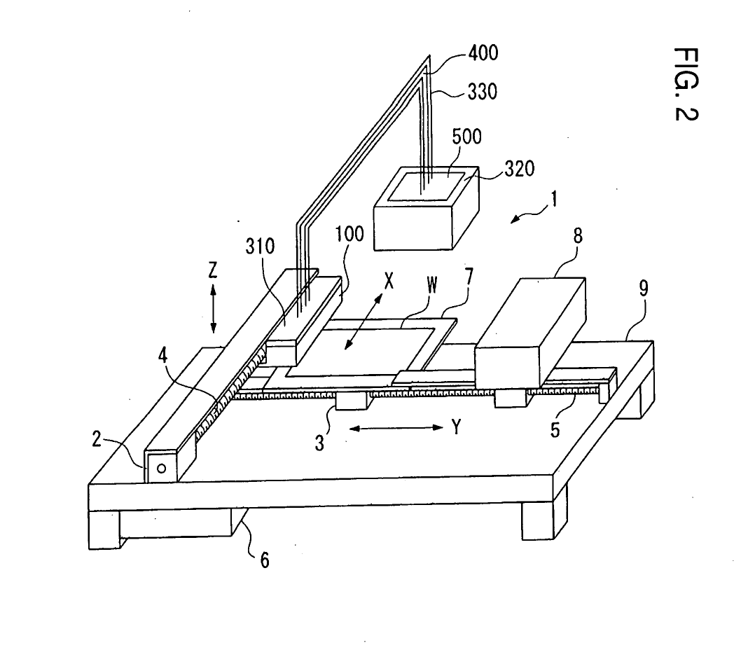

FIG. 2 is a schematic perspective view showing a whole structure of an exemplary inkjet apparatus as a liquid crystal discharge apparatus to which the invention is applied. As shown in FIG. 2, an inkjet apparatus 1 of an embodiment includes a discharge head 100, an X-way driving mortar 2, an X-way drive axis 4, a Y-way driving mortar 3, a Y-way guide axis 5, a controller 6, a stage 7, a cleaning mechanical section 8, a table 9 and a suction mechanism 10.

The discharge head 100 has a plurality of discharge nozzles arranged in an X direction. A liquid crystal stored in a liquid crystal tank 500 is supplied to the discharge nozzles through a supply pipe 400 (a path of flow), and then it is discharged from each of the discharge nozzles. The discharge head 100 has a first heater 310, the liquid crystal tank 500 has a second heater 320, and the supply pipe 400 has a third heater 330.

The stage 7 is for mounting a substrate W to which the liquid crystal is discharged from the discharge head 100, and has a feature to fix the substrate W in a predetermined reference position.

The X-way drive axis 4 is composed of ball screws and so on, and the X-direction driving motor 2 is connected on its end. The X-direction driving motor 2 is a stepping mortar for example, and rotates the X-direction drive axis 4 when an X-direction driving signal is provided from the controller 6. When the X-direction drive axis 4 is rotated the discharge head 100 moves in the X direction along the X-direction drive axis 4.

The Y-direction guide axis 5 is also composed of ball screws and so on, and provided at a predetermined position on the table 9. The stage 7 is provided on the Y-direction guide axis 5 and has the Y-direction driving motor 3. The Y-direction driving motor 3 is a stepping motor for example, and moves in Y direction with guidance of the Y-direction guide axis 5 when a Y-direction driving signal is provided from the controller 6. As described above, the discharge head 100 can move relatively to the predetermined place on the substrate W with an X-direction drive and a Y-direction drive.

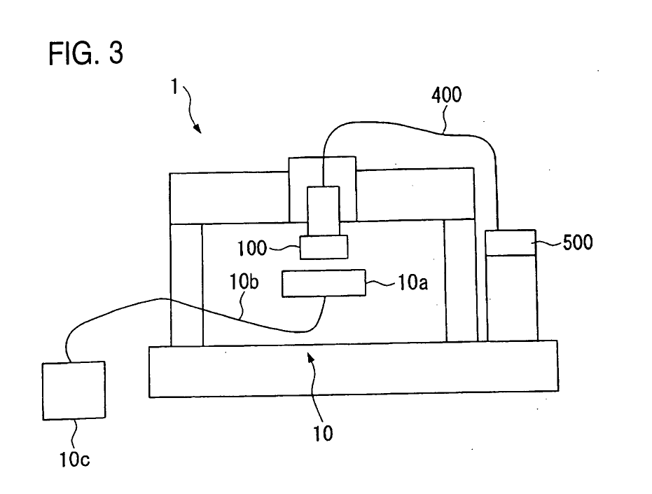

The suction mechanism 10 which is for filling the liquid crystal in the discharge head 100 is equipped at the X-axis side of the discharge head 100, as shown in FIG. 3.

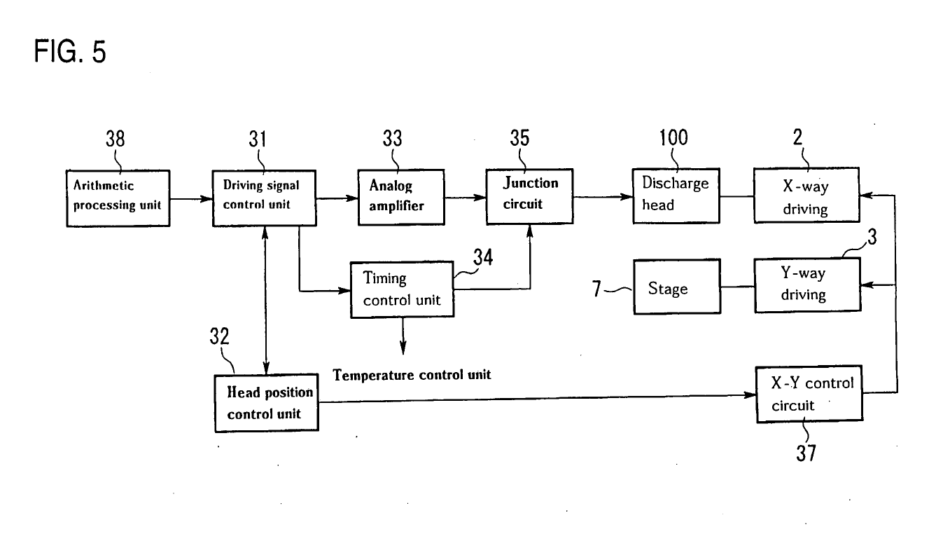

The controller 6 has a driving signal control unit 31 which supplies a control signal for discharging the liquid crystal to the discharge head 100, as shown in FIG. 5. A detailed description of the controller 6 is given later with reference to FIG. 5. The controller 6 also has a head position control unit 32. The head position control unit 32 supplies a signal, which controls a positional relationship between the discharge head 100 and the stage 7, to the X-direction driving motor 2 and the Y-direction driving motor 3. The controller 6 also has a temperature control unit 300 which is described later.

The cleaning mechanical section 8 prevents the discharge nozzles (the discharge head) from being clogged by, for example, wiping out ends of the nozzles formed in the discharge head 100. The cleaning mechanical section 8 has a Y directional driving motor (not shown in figures), and the cleaning mechanical section 8 is driven by the driving motor and moves along with the Y-direction guide axis 5. This movement of the cleaning mechanical section 8 is also controlled by the controller 6.

The inkjet apparatus 1 includes the suction mechanism 10 as shown in FIG. 3. The suction mechanism 10 is composed of a nozzle cap 10a, a tube 10b which is connected with the nozzle cap 10a and a suction pump 10c which is connected with the tube 10b. The nozzle cap 10a is placed on a discharge face of the discharge head 100, that is where the discharge nozzles are formed.

The nozzle cap 10a has a pad (not shown in the figure) which is adjacent to the discharge face and covers the nozzles. The pad has a hole (not shown in the figure) through which the tube 10b is connected. The pad is made of rubber or soft synthetic resin and the like and appressed[?] to a face of the discharge head 100 where the nozzles are formed.

The suction pump 10c is a vacuum pump or a process pump. The suction pump 10c vacuums up air in the discharge head 100 at negative pressure through the tube 10b and the nozzle cap 10a, and liquid in the liquid crystal tank 500 is forcibly introduced into the discharge head 100. By this suction mechanism 10, the liquid crystal is first filled in the discharge head 100 which was filled with the air or a certain gas. A tank (not shown in the figure) is connected with the suction pump 10c, and the liquid crystal runs out of the discharge head 100 is collected into the tank. According to the present invention, a suction device may be composed of the suction pump 10c only or the suction pump 10c and the tube 10b.

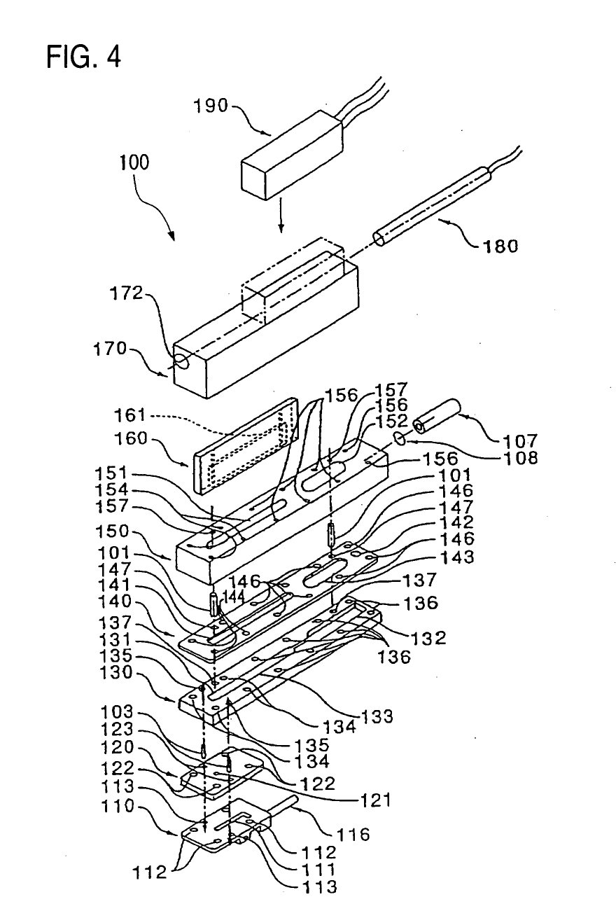

FIG. 4 is an exploded perspective view of the discharge head 100 according to an embodiment of the present invention. The inkjet apparatus 1 includes a plurality of discharge heads 100 though FIG. 4 shows one of them. The discharge head 100 includes a nozzle forming board holding member 110, a nozzle forming board 120, a cavity forming board 130, a vibrant board 140, a case 150, a pressure generating elements assembly 160 and a heater housing 170.

A cartridge heater 180 can be provided in the heater housing 170 and installed as the first heater 310 in the discharge head 100. A temperature sensor 190 (a first temperature sensor 315) is also installed in the discharge head 100.

The nozzle forming board holding member 110 is a rectangular metal board and has a pass-through slot 111 which is L-shape. A through-hole 112 is formed at four corners of the nozzle forming board holding member 110, and a small hole 113 which is for positioning is also formed on both sides of the pass-through slot 111. Further, a suction pipe 116 for removing a surplus liquid crystal is connected with the nozzle forming board holding member 110.

The nozzle forming board 120 is a rectangular metal board and a nozzle opening 121 is formed at its center. A through-hole 122 is formed at four corners of the nozzle forming board 120, and a small hole 123 which is for positioning is also formed on both sides of the nozzle opening 121. The through-hole 111 and the through-hole 112 are formed to overlap each other when the nozzle forming board holding member 110 is placed on a lower side of the nozzle forming board 120, the small hole 113 and the small hole 123 are also formed to overlap each other.

In a case that the liquid crystal is hydrophilic, use the nozzle forming board 120 whose surface is treated to be water-shedding. In a case that the liquid crystal is water-shedding, use the nozzle forming board 120 whose surface is treated to be hydrophilic. This prevents the liquid crystal from sticking around the nozzle opening 121.

Also, the larger nozzle opening 121 formed on the nozzle forming board 120 is used, the higher viscosity liquid crystal can be discharged. On the contrary, in a case that the liquid crystal has a low viscosity, the nozzle forming board 120 which has a small nozzle opening 121 is used to stabilize a discharge rate.

The cavity forming board 130 is a rectangular silicon board which is larger than the nozzle forming board 120. In the cavity forming board 130, a path of flow 133 which is composed of a cavity 131 (a pressure generating room) and a reservoir 132 is formed. The cavity 131 is placed to be connectable with the nozzle opening 121, and the reservoir 132 is connected with the cavity 131 through a constricted portion. A through-hole 134 and a small hole 135 for positioning are formed in the cavity forming board 130. The cavity forming board 130 has four through-holes 134. The through-hole 134 and the through-hole 122 are formed to overlap each other when the nozzle forming board 120 is placed on a lower side of the cavity forming board 130. The small hole 135 and the small hole 123 are also formed to overlap each other. Further, in the cavity forming board 130, six through-holes 136 are formed in an area which is from a center to the long side of the board to where the reservoir 132 is. Two positioning holes 137 which are larger than the small hole 135 are also formed in the area.

The cavity forming board 130 which has the larger sectional area of the path of flow 133 is used, the higher viscosity liquid crystal can be discharged. On the contrary, in a case that the liquid crystal has a low viscosity, the cavity forming board 130 which has a-small sectional area of the path of flow 133 is used to stabilize a discharge rate.

The vibrant board 140 is a rectangular metal board that is about the same size as the cavity forming board 130. The vibrant board 140 has a thin vibrant board portion 141, a feed opening 142 and a thin heat transfer portion 143. The vibrant board portion 141 is formed to overlap the cavity 131 when the vibrant board 140 is placed on an upper side of the cavity forming board 130. The feed opening 142 and the heat transfer portion 143 are formed to overlap the reservoir 132 when the vibrant board 140 is placed on the upper side of the cavity forming board 130. Also, the vibrant board 140 has a through-hole 144, a through-hole 146 and a positioning hole 147. These holes are formed to overlap the through-hole 134, the through-hole 136 and the positioning hole 137 formed in the cavity forming board 130 respectively.

The case 150 is made of a thick metal member which is as large as the vibrant board 140. The case 150 has a first opening 151 for setting a position of an element and a second opening 152. The first opening 151 is formed to overlap the cavity 131 when the vibrant board 140 is placed on a lower side of the case 150. The second opening 152 is also formed to overlap the heat transfer portion 143. The case 150 also has a screw hole 154, a screw hole 156 and a positioning hole 157. These holes are formed to overlap the through-hole 144, the through-hole 146 and the positioning hole 147 formed in the vibrant board 140 respectively.

Inside of the case 150 is partially hollow. On a lower surface of the case 150, a first feed opening (not shown in the figure) is formed to overlap the feed opening 142 formed in the vibrant board 140. On a rear end surface of the case 150, a second feed opening (not shown in the figure) is formed to be connected and be led from the first feed opening. In the present embodiment, a liquid supply channel 107 is connected to the second opening of the case 150 through a mesh filter 108. Each discharge head 100 has the liquid supply channel 107 and the liquid supply channel 107 is connected to the supply pipe 400 which is led from the liquid crystal tank 500 (see FIG. 2).

Further, on the lower face of the case 150, the vibrant board 140, cavity forming board 130, the nozzle forming board 120 and the nozzle forming board holding member 110 are placed in piles in this order.

The nozzle forming board 120 and the nozzle forming board holding member 110 are placed together in this order on the lower side of the cavity forming board 130, and these boards are set their position by installing locating pins 103 in the small holes 113, 123 and 135. Then, a screw 104 is installed in the screw hole 154 through the through-holes 112, 122, 134 and 144, and then the vibrant board 140, cavity forming board 130, the nozzle forming board 120 and the nozzle forming board holding member 110 are fixed in piles on the lower face of the case 150 in this order.

On the other hand, above the case 150, the pressure generating elements assembly 160 is putted on the first opening 151 from its lower end. The pressure generating elements assembly 160 can include a pressure generating element 161 which is a piezoelectric vibrator. At the same time, the lower end of the pressure generating elements assembly 160 (a lower end of the pressure generating element 161) is fixed to the vibrant board portion 141 in the vibrant board 140 with an adhesive agent.

Also, above the case 150, the heater housing 170 is installed to cover the pressure generating elements assembly 160. The heater housing 170 has a through-hole (not shown in the figure) which is formed to overlap the screw hole of the case 150 when the heater housing 170 is placed on an upper side of the case 150. Therefore, the heater housing 170 is fixed on the case 150 by installing the screws (not shown in the figure) into the screw holes formed in the case 150 through the through-holes formed in the heater housing 170.

Further, the heater housing 170 has a heater mounting hole 172 which run through the heater housing 170 in a transverse direction. In the heater mounting hole 172, a cartridge heater 180 which is a round bar shape is installed. A step formed on an upper surface of the heater housing 170 is used to install the temperature sensor 190 as shown with an alternate long and short dash line. The temperature sensor 190 is fixed to the heater housing 170 with a L-plate or screws (not shown in the figure).

In the above-described discharge head 100, when a predetermined driving voltage is applied to the pressure generating element 161 from a junction circuit 35, the vibrant board portion 141 in the vibrant board 140 vibrates with a deformation of the pressure generating element 161. The junction circuit 35 is described below with reference to FIG. 5. While the vibrant board portion 141 vibrates, a capacity of the cavity 131 is expanded. After that, the capacity of the cavity 131 is contracted and an inside of the cavity becomes a positive pressure. Consequently, the liquid crystal in the cavity is discharged as a droplet at a predetermined position on the substrate W from the nozzle opening 121 (an end part of the discharge nozzle).

FIG. 5 is an exemplary block diagram showing a control system for the inkjet apparatus 1 according to an embodiment of the invention. In the inkjet apparatus 1, the controller 6 has the driving signal control unit 31 and the head position control unit 32.

The driving signal control unit 31 outputs a waveform to drive the discharge head 100. The driving signal control unit 31 also outputs a bitmap data, which is, for example, indicating which one to be used out of the plurality of the discharge nozzles and when to discharge the liquid crystal.

The driving signal control unit 31 is connected with an analog amplifier 33 and a timing control unit 34. The analog amplifier 33 amplifies the waveform and makes it to have a certain voltage. The timing control circuit 34 includes a clockpulse circuit and controls timing in discharging the liquid crystal in accordance with a drive frequency which is set by the bitmap data and the clockpulse circuit.

The analog amplifier 33 and the timing control circuit 34 are both connected to the junction circuit 35. The junction circuit 35 supplies the drive voltage outputted from the analog amplifier to the discharge head 100, according to a timing signal which has a predetermined drive frequency and outputted from the timing control circuit 34.

The head position control unit 32 is a circuit which controls the positional relationship between the discharge head 100 and the stage 7. The head position control unit 32 also manages the droplet of the liquid crystal discharged from the discharge nozzle to land in the predetermined position on the substrate W in corporation with the driving signal control unit 31. The head position control unit 32 is connected to an X-Y control circuit 37 and outputs a information about a relative position between the discharge head 100 and the stage 7 to the X-Y control circuit 37.

The X-Y control circuit 37 is connected with the X-direction driving motor 2 and the Y-direction driving motor 3, and outputs signals which control the position of the discharge head 100 on the X-axis and the position of the stage 7 on the Y-axis in accordance with a signal outputted from the head position control unit 32.

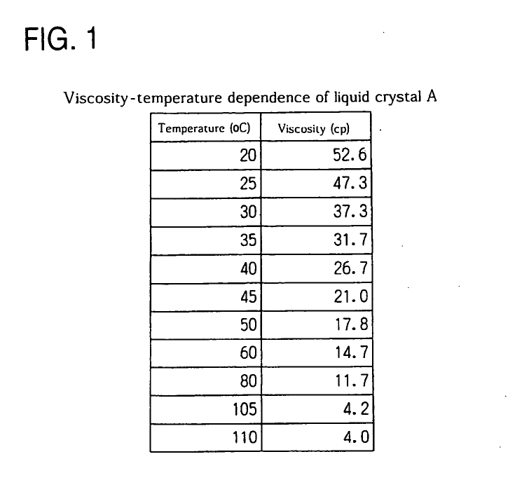

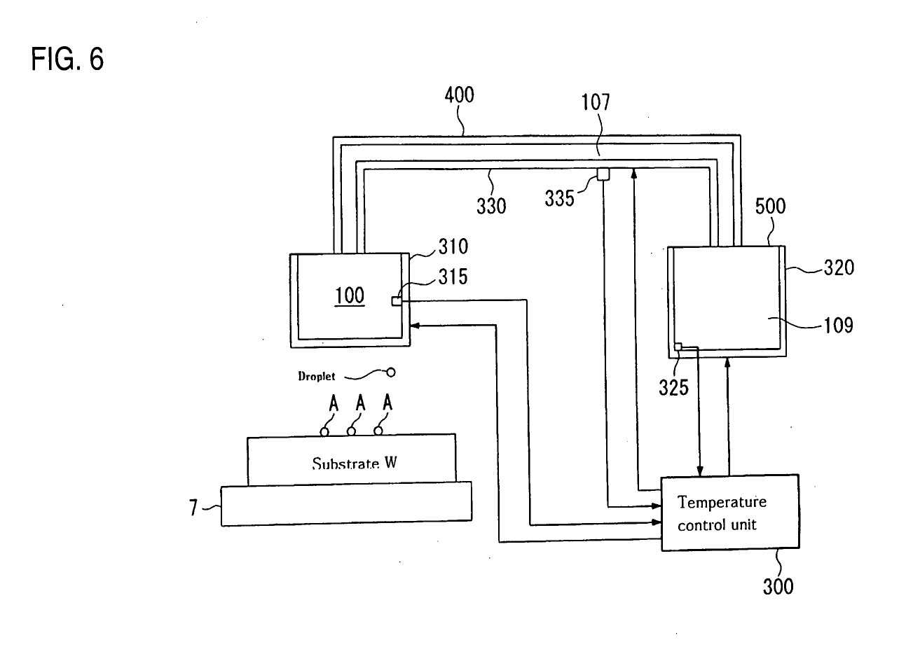

FIG. 6 is an exemplary block diagram showing a structure (a heating portion) which controls a temperature of the inkjet apparatus 1 shown in FIG. 1. As shown in FIG. 6, the first heater 310 and the first temperature sensor 315 (an assembly of the temperature sensors 190 in FIG. 4) are provided in the discharge head 100, the second heater 320 and a second temperature sensor 325 are provided in the liquid crystal tank 500, and the third heater 330 and a third temperature sensor 335 are provided in the supply pipe 400. Though thermal insulation members and the like are also provided in the each part, they are omitted in FIG. 6.

The temperature control unit 300 can be provided in the controller 6 shown in FIG. 2. The first temperature sensor 315, the second temperature sensor 325 and the third temperature sensor 335 are designed to monitor temperatures of the discharge head 100, the liquid crystal tank 500 and the supply pipe 400, respectively, and sent results to the temperature control unit 300.

Based on the results of the each temperature sensors 315, 325 and 335, the temperature control unit 300 controls the first heater 310, the second heater 320 and the third heater 330 individually. Therefore, according to an exemplary embodiment of the invention, the temperatures of the discharge head 100, the liquid crystal tank 500 and the supply pipe 400 are controlled and set individually to certain temperatures. Also, the third heater 330 may be provided in the whole of the supply pipe 400, or may only be provided at a vicinity of the discharge head 100 in the supply pipe 400.

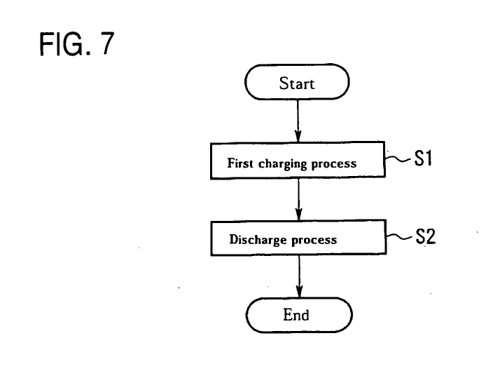

An exemplary method for discharging the liquid crystal on the substrate W with the inkjet apparatus 1 is described with reference to a flowchart shown in FIG. 7.

Firstly, a first charging process (Step S1) is taking place. In the first charging process, the controller 6 fills the liquid crystal A from the liquid crystal tank 500 into the discharge head 100 through the supply pipe 400 by suctioning up the inside of the discharge head 100 at the negative pressure with the suction mechanism 10. The controller 6 also controls the first heater 310, the second heater 320 and the third heater 330 individually, and at least the liquid crystal A in the discharge head 100 is heated till it reaches a temperature which exceeds the transition point (a heat processing). It is preferred that the controller 6 also controls the second heater 320 and the third heater 330 to heat the liquid crystal A in the liquid crystal tank 500 and the supply pipe 400 till they reach the temperature which exceeds the transition point.

As described above, the liquid crystal A, which is heated to the temperature which exceeds the transition point, is charged in the discharge head 100 without catching air bubbles, since its viscosity is extremely reduced as shown in FIG. 1. Therefore, the liquid crystal A can be discharged from all the discharge nozzles formed in the discharge head 100 without clogging the discharge nozzles.

Secondly, a discharge process (Step 2) is taking place. In the discharge process, the controller 6 makes the discharge head 100 discharge the liquid crystal A to the predetermined area on the substrate W as moving the stage 7 and the discharge head 100 relatively. And then, a predetermined amount of the liquid crystal A is allocated in the predetermined area on the substrate W mounted on the stage 7.

In this process, since the liquid crystal A at least in the discharge head 100 has the temperature which exceeds the transition point in the first charging process, it is preferred that the liquid crystal A is discharged after it is cooled down until it becomes a predetermined temperature by, for example, leaving for a certain time. This is because its viscosity is quite low when the liquid crystal has the temperature exceeding the transition point and it might spread over the predetermined area and make the substrate wet.

As described above, an amount of the liquid crystal A allocated in the predetermined area should be precise since it is discharged from the clogging free discharge head 100 in the first charging process. Therefore, according to the method and the apparatus for discharging the liquid crystal, a predetermined amount of the liquid crystal is stably discharged and allocated by securely filling the liquid crystal in the discharge head.

A liquid crystal device which is obtained by using the above-described method for discharging the liquid crystal is described.

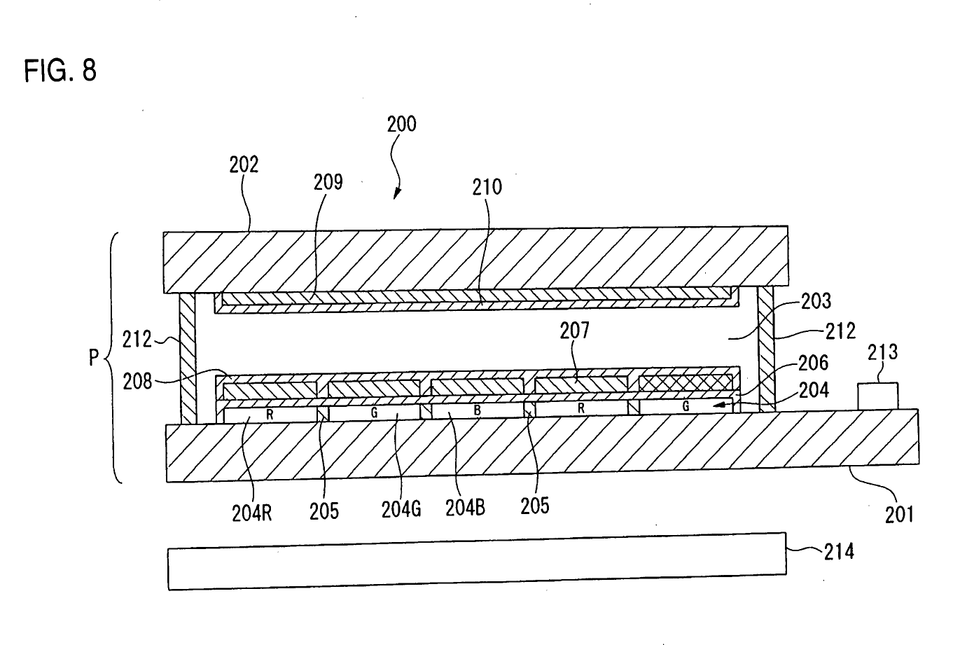

FIG. 8 is a section view showing a frame format of a structure of an exemplary passive matrix liquid crystal device. A liquid crystal device 200 is a transmissive type and includes a liquid crystal panel P, a driver IC 213 and a back light 214 as a light source. The liquid crystal panel P is composed of a pair of glass substrates 201 and 202 and a liquid crystal layer 203 which is made of a Super Twisted Nematic (STN) liquid crystal and the like. The liquid crystal layer 203 is interposed between the pair of glass substrates.

A color filter 204 is disposed on an inner surface of the glass substrate 201 (the substrate W). The color filter 204 is formed by arranging a red (R) colored layer 204R, a green (G) colored layer 204G and a blue (B) colored layer 204B regularly. Between these colored layers 204R (204G, 204B), a partition wall 205, which is a bank or a black matrix, is formed. Also, an overcoat film 206 is formed on the color filter 204 and the partition wall 205. The overcoat film 206 is formed to eliminate difference in level due to the color filter 204 and the partition wall 205, and to planarize a surface.

A plurality of electrodes 207 are formed in a striped pattern on the overcoat film 206. On top of the electrodes 207, an alignment film 208 is formed.

On an inner surface of another glass substrate 202, a plurality of electrodes 209 are formed in the striped pattern to cross the electrodes on the color filter 204 side orthogonally. An alignment film 210 is formed on the electrodes 209. Each colored layers 204R, 204B and 204G in the color filter 204 is placed at a intersection where the electrode 209 on the glass substrate 202 and the electrode 207 on the glass substrate 201 cross. The electrodes 207 and 209 are formed of a transparent conductive material such as Indium Tin Oxide (ITO). A deflecting plate (not shown in the figure) is provided at outer sides of the glass substrate 202 and the color filter 204. Between the glass substrates 201 and 202, a spacer (not shown in the figure) and a seal member 212 are provided. The spacer keeps a cell gap between the glass substrates 201 and 202 constant. The seal member 212 shuts off the air from the liquid crystal layer 203, and it is made of, for example, a heat-hardening resin or a photo-curable resin.

In this exemplary liquid crystal device 200, the above-described liquid crystal layer 203 is placed on the glass substrate by the above-described method and apparatus for discharging the liquid crystal. Therefore, a predetermined amount of the liquid crystal is stably allocated on the glass substrate and it prevents display unevenness from occurring. Consequently, visibility of the liquid crystal device is improved.

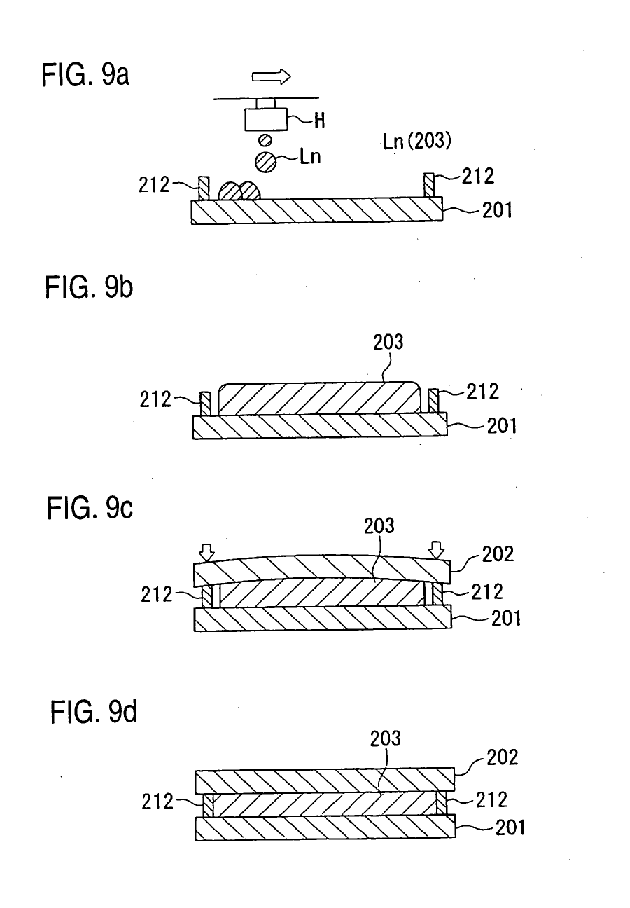

FIG. 9(a) through FIG. 9(d) are schematically showing a method for manufacturing the above-described liquid crystal panel P. FIG. 9(a) and FIG. 9(b) show a process in which the predetermined amount of the liquid crystal is allocated on the glass substrate. FIG. 9(c) and FIG. 9(d) show a process in which the liquid crystal is sealed (a bonding process). In the interest of brevity, the electrode on the glass substrate, the color filter, the spacer and the like are omitted in FIG. 9(a) through FIG. 9(d).

In FIG. 9(a) and FIG. 9(b), in the process disposing the liquid crystal, the predetermined amount of the liquid crystal is allocated on the glass substrate 201. More specifically, as shown in FIG. 9(a), after the liquid crystal is heated in the discharge head 100 and made into a droplet Ln, the droplet Ln is discharged from the discharge nozzle and disposed on the glass substrate 201, as moving the glass substrate 201 and the discharge head 100 relatively based on the bitmap. Then, the predetermined amount of the liquid crystal is disposed on the glass substrate 201 as shown in FIG. 9(b). The predetermined amount of the liquid crystal that is supposed to be disposed on the glass substrate 201 is as same as a volume of a space formed between the glass substrates after the liquid crystal is sealed.

In this embodiment, since the liquid crystal is discharged from the discharge nozzles without clogging it, the predetermined amount of the liquid crystal 203 can be constantly allocated on the glass substrate 201.

Next, in FIG. 9(c) and FIG. 9(d), the glass substrate 201 on which the predetermined amount of the liquid crystal is disposed and the another glass substrate 202 are bonded together under reduced pressure, with the seal member 212 interposed therebetween.

More specifically, pressure is mainly put on edges of the glass substrate 202 and the glass substrate 201 on which the seal member 212 is disposed, and then the seal member 212 and the glass substrates 201 and 202 are bonded as shown in FIG. 9(c). Leaving them for a certain time and the seal member 212 is dried in a certain degree, and then put pressure on the whole outer surface of the glass substrates 201 and 202 and let the liquid crystal 203 spread throughout the space between the glass substrates 201 and 202.

In this case, since the seal member 212 has been already dried to the certain degree by the time when the liquid crystal 203 contacts with the seal member 212, a performance of the seal member 212 is less degraded and the liquid crystal 203 is less deteriorated.

Then, the seal member 212 is harden by giving heat or light to the seal member 212 and the liquid crystal is sealed between the glass substrates 201 and 202.

With the liquid crystal device manufactured in this manner, less amount of the liquid crystal is consumed and it results in a lower cost. Also, the display will not be deteriorated due to the unevenness of the liquid crystal display.

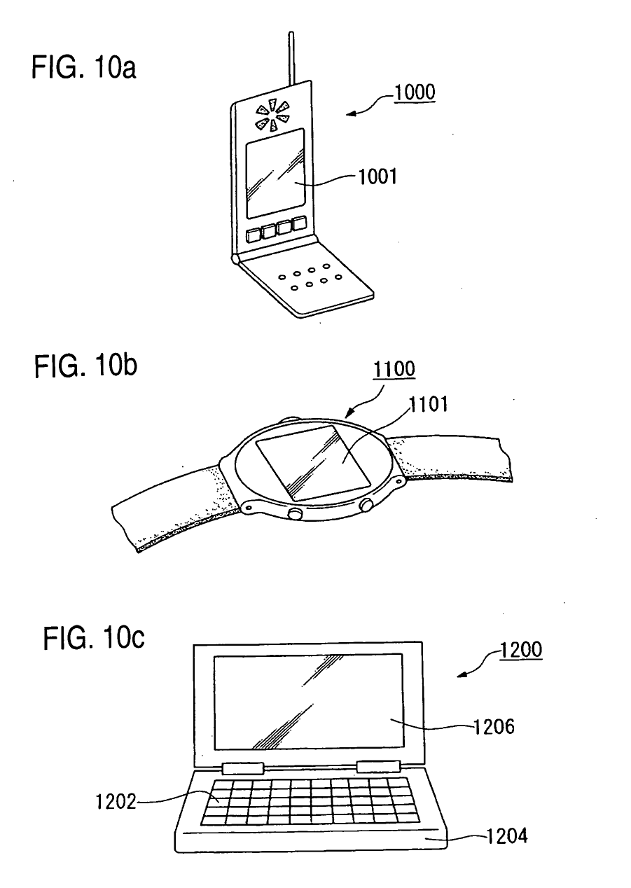

FIG. 10(a) through FIG. 10(c) is showing embodiments of an electronic equipment according to the present invention. The electronic equipment according to the embodiments has the liquid crystal device according to the present invention as a display means.

FIG. 10(a) is a perspective view of a mobile phone as an example. In FIG. 10(a), reference numeral 1000 refers to a body of the mobile phone and reference numeral 1001 refers to a display part in which the above-described liquid crystal device is employed.

FIG. 10(b) is a perspective view of a watch type electronic equipment as an example. In FIG. 10(b), reference numeral 1100 refers to a body of the watch type electronic equipment and reference numeral 1101 refers to a display part in which the above-described liquid crystal device is employed.

FIG. 10(c) is a perspective view of a potable information-processing device, such as a word processor and a personal computer, as an example. In FIG. 1 0(c), reference numeral 1200 refers to the information-processing device, reference numeral 1202 refers to an input unit such as a keyboard reference numeral 1204 refers to a body of the information-processing device, and reference numeral 1206 refers to a display part in which the above-described liquid crystal device is employed.

The electronic equipments showed in FIG. 10(a) through FIG. 10(c) have the liquid crystal device according to the present invention as a display means, therefore, their visibility is high and their qualities are improved.

In these embodiments the liquid crystal device is a passive matrix type, though, the liquid crystal device may be an active matrix type which includes a thin film diode (TFD) or a thin film transistor (TFT) as a switching element.

Although the present invention has been fully described by way of example with reference to the accompanying drawings, it is to be understood that it is not limited to the exemplary embodiments described above. Configuration or combination of the above-mentioned members in the embodiments are just examples, and various changes and modifications will be applied within the scope and spirit of the invention.

1. A method for discharging liquid crystal, comprising:
discharging the liquid crystal from a discharge head and disposing the liquid crystal in a predetermined area on a substrate; and
heat processing to heat the liquid crystal so that the liquid crystal reaches a temperature that exceeds a transition point of the liquid crystal.

2. The method for discharging liquid crystal according to claim 1, further comprising:
a charging process at a first stage to charge the liquid crystal to the discharge head, the heat processing being carried out in a first charging process at the first stage.

3. An apparatus that discharges liquid crystal, comprising:
a discharge head that discharges liquid crystal in a predetermined area on a substrate; and
a first heater heating the liquid crystal in the discharge head until the liquid crystal reaches a temperature that exceeds the transition point of the liquid crystal.

4. The apparatus that discharges liquid crystal according to claim 3, further comprising:
a liquid crystal tank in which the liquid crystal is stored;
a path of flow connecting the liquid crystal tank and the discharge head;
a second heater that heats the liquid crystal tank; and
a third heater that heats the path of flow.

5. The apparatus that discharges liquid crystal according to claim 3, further comprising:
a suction device that suctions up an inside of the discharge head at an negative pressure and charges the liquid crystal into the discharge head; and
a controller that controls the first heater to heat the liquid crystal at least until the liquid crystal reaches a temperature that exceeds the transition point in the suction device's suctioning the liquid crystal into the discharge head.

6. A method of manufacturing a liquid crystal device, comprising a liquid crystal discharging and disposing process in which the liquid crystal is allocated in a predetermined area on a substrate by the method for discharging liquid crystal according to claim 1.

7. A liquid crystal device obtained by the method of manufacturing the same according to claim 6.

8. An electronic equipment, comprising the liquid crystal device according to claim 7 as a display device.
